(19) United States
(12) Patent Application Publication
(10) Pub. No.: US 2022/0389731 A1
(43) Pub. Date: Dec. 8, 2022

(54) VESSELS SUCH AS SWIMMING POOLS OR SPAS OMITTING DEDICATED PLUMBED WATER-CIRCULATION SYSTEMS

(71) Applicant: ZODIAC POOL CARE EUROPE, Belberaud (FR)

(72) Inventor: E. Keith McQueen, Vista, CA (US)

(73) Assignee: ZODIAC POOL CARE EUROPE, Belberaud (FR)

(21) Appl. No.: 17/833,146

(22) Filed: Jun. 6, 2022

Related U.S. Application Data
(60) Provisional application No. 63/197,913, filed on Jun. 7, 2021.

(51) Int. Cl. E04H 4/16; E04H 4/12; C02F 1/00

(52) U.S. Cl. CPC E04H 4/1654; E04H 4/1263; C02F 1/001; E04H 4/1281; C02F 2203/008; C02F 2201/006

(57) ABSTRACT

An automatic swimming pool cleaner (APC) may be used as a primary or sole water-circulation system of a pool or spa. The pool or spa hence need not employ dedicated water-circulation equipment, unlike conventional such vessels. In some cases, the APC includes a water treatment system for dispensing one or more chemicals for sanitizing (or otherwise treating) pool water.

### REFERENCE TO RELATED APPLICATION

This application claims the benefit of U.S. Provisional Patent Application No. 63/197,913, filed on Jun. 7, 2021 and entitled VESSELS SUCH AS SWIMMING POOLS OR SPAS OMITTING DEDICATED PLUMBED WATER-CIRCULATION SYSTEMS, the content of which is hereby incorporated by reference in its entirety.

### FIELD OF THE INVENTION

This invention relates to fluid-containing vessels such as swimming pools and spas and more particularly, although not necessarily exclusively, to equipment, systems, and methods for filtering and circulating water contained in such vessels without need for conventional dedicated water-circulation systems.

### BACKGROUND OF THE INVENTION

Numerous swimming pools, spas, and other water-containing vessels currently exist. Many swimming pools are categorized as either “in ground” or “above ground,” depending principally on whether or not the bottom surfaces and generally vertically walls of the pools extend into the ground (below grade). In either case, however, the pools typically include external filtration systems often comprising dedicated pumps, filters, skimmers, and plumbing allowing pool water to exit a pool, pass through the dedicated equipment, and thereafter re-enter the pool.

As an example, U.S. Patent Application Publication No. 2002/0178494 of Marbach, whose entire contents are incorporated herein by this reference, illustrates one of many alternatives for providing a dedicated skimmer to an above-ground pool. The skimmer is fixed to a wall of the pool and intended to receive debris-laden water from the pool. A flexible pouch of the skimmer, further, may protrude externally through a cut-out made in a side wall of a rigid above-ground pool.

Likewise known for filtering pool water are automatic swimming pool cleaners (APCs). APCs often are hydraulic or robotic in type, with hydraulic cleaners varying water flow for movement and robotic cleaners usually employing electric motors to cause motion. Robotic cleaners, especially, are designed to move autonomously within pools and vacuum debris-laden water into on-board filters. U.S. Patent Application Publication No. 2021/0032888 of Lancry, et al., whose entire contents are incorporated herein by this reference, details an exemplary robotic APC useful to clean water of an illustrated swimming pool. In use, a pump on-board the APC operates to draw pool water into the cleaner, where the water passes through the filter (so as to trap debris entrained in the flowing water) before exiting to return to the pool.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, disclosed is a “pipeless” vessel such as a swimming pool or spa.

According to various embodiments, an APC operates as the primary, if not sole, water-circulation system of a pool or spa. In some embodiments, the APC may include a water-treatment chemical.

According to some embodiments, disclosed is a method of filtering water of a pool comprising (a) introducing an APC into water of a pool lacking operational dedicated water-circulation equipment and (b) operating the APC in the pool.

Various implementations described herein may include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 is a top view of a pipeless pool with an APC as a water circulation device according to embodiments.

FIG. 2 is a sectional view of the pool of FIG. 1.

FIG. 3 illustrates the APC of FIG. 1 with a water treatment system according to embodiments.

FIG. 4 illustrates the APC of FIG. 3 with the water treatment system at a first configuration according to embodiments.

FIG. 5 illustrates the APC of FIG. 3 with the water treatment system at a second configuration according to embodiments.

### DESCRIPTION OF THE INVENTION

Described herein are pipeless pool or spa systems and associated methods in which the water-containing vessel (e.g., pool or spa) above ground or in ground does not require plumbed systems for purposes of circulating and filtering pool water. In contrast with kiddie or wading pools that are movable by a single person, the pools described herein are permanent or semi-permanent vessels that have traditionally required plumbed circulation and filtration systems and are not easily movable without requiring significant disassembly of such vessels.

In certain embodiments, the systems and methods described herein use a portable circulation and filtration device (hereinafter “circulation device”) within the pool for circulating and filtering pool water without being plumbed, fixed, or otherwise dedicated to the pool. In certain embodiments, the circulation device may be an APC such as a robotic or other type of APC that acts as a water circulation system functional within pools. The portable circulation device, such as the APC, may be used in lieu of plumbed systems for purposes of circulating and filtering pool water. APCs (or other circulation devices) operating as water-circulation systems additionally may dispense one or more chemicals for sanitizing (or otherwise treating) pool water. Hence, no dedicated filtration equipment and plumbing need necessarily be utilized when an APC is available, and a so-called “pipeless” pool may be created. Such a “pipeless” pool may be substantially less complex than existing designs. It also may be substantially less expensive than conventional pools. Avoiding need for plumbed equipment additionally could reduce ongoing maintenance requirements and costs, as only the APC itself need be maintained.

While multiple APCs include both a pump and a filter, relatively few APCs are configured to act as skimmers within pools. However, at least some APCs operate in this manner, both vacuuming water as they move along submerged surfaces within pools and rising to pool waterlines to skim debris from water at the waterlines. U.S. Patent Application Publication No. 2020/0347630 of Durvasula, et al., whose entire contents are incorporated herein by this reference, discloses an example of such an APC, which again could be used to supplant any dedicated water-circulation system in a pool. Of course, even if not supplanting a dedicated system, an APC could supplement one—and indeed could become a primary (rather than secondary) water-circulation system for a pool or spa.

Methods of the invention optionally include furnishing a “pipeless” above-ground or in-ground swimming pool without, e.g., an operational filter, pump, skimmer, or plumbing. The methods additionally may comprise operating an APC within the pool so as to circulate and filter water of the pool. Some alternate methods of the invention may include furnishing a swimming pool wholly lacking any dedicated water-circulation equipment, while other alternate methods will continue to employ dedicated equipment but use it secondarily to an APC functioning as the primary water-circulation system. Various other benefits and advantages may be realized with the systems and methods provided herein, and the aforementioned advantages should not be considered limiting.

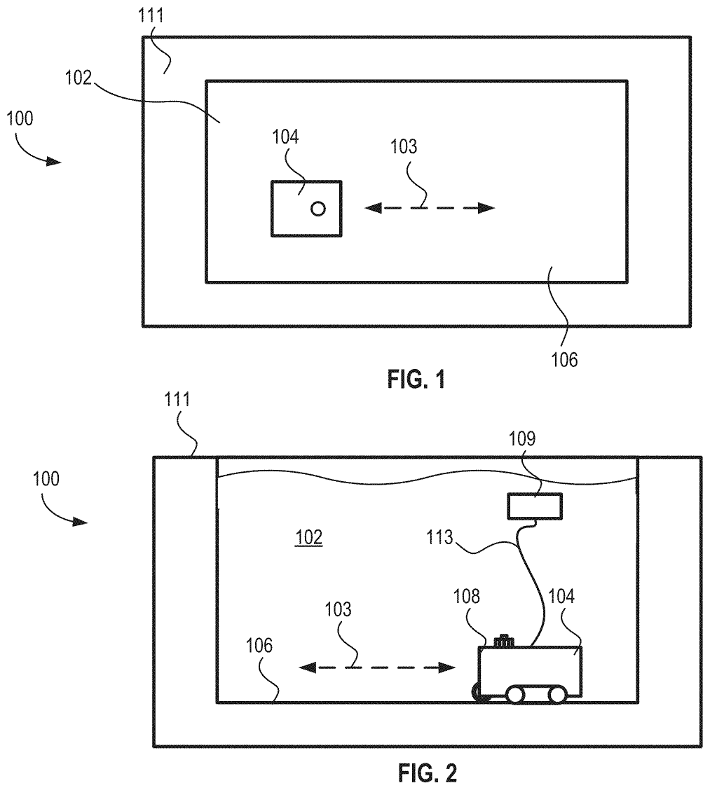

FIGS. 1 and 2 illustrate a pool system 100 with a pool 102 and a portable circulation device 104 according to embodiments. The pool 102 is illustrated as in in ground pool, and a bottom surface 106 of the pool 102 is below a ground surface 111 surrounding the pool 102. The pool 102 is also illustrated as a pipeless pool 102 and lacks a dedicated external circulation and filtration system in which dedicated pumps, filters, skimmers, and plumbing allow pool water to exit a pool, pass through the dedicated equipment, and thereafter re-enter the pool. Instead, the pool system 100 includes the circulation device 104 as a water circulation system for circulating pool water.

The circulation device 104 may be provided within the pool 102 and is portable and movable relative to the pool 102 (represented by arrows 103). In other words, the circulation devices is movable within the pool 102, e.g., to traverse the bottom surface 106, and may be removed from the pool 102 as desired. The circulation device 104 may be corded or cordless as desired.

In some embodiments, the circulation device 104 may be an APC 108. Optionally, and as illustrated in FIG. 2, a skimmer 109 may be used with the APC 108. In some embodiments, the skimmer 109 may be cordless relative to the APC 108. In other embodiments, and as illustrated in FIG. 2, the skimmer 109 may be corded or otherwise tethered via a tether 113 to the APC 108 such that the skimmer 109 is towed by the APC 108. Other suitable types of circulation devices 104 within the pool 102 may be utilized as desired.

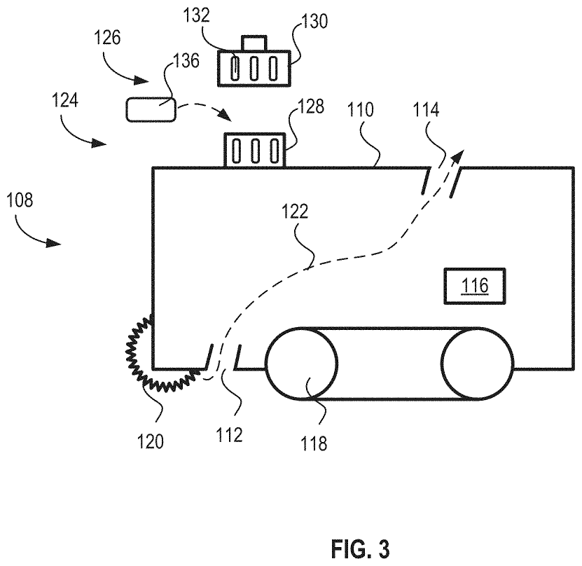

As illustrated in FIGS. 3-5, in some embodiments, the APC 108 includes a body 110 with one or more inlets 112 and one or more outlets 114. The APC 108 may include one or more of a pump 116, motive elements 118 (e.g., wheels, tracks, etc.), an optional cleaning device 120 (e.g., a brush assembly or other suitable device), a filter, any suitable electric or other motors, a controller (e.g., processor and memory), communication modules (e.g., facilitating wired and/or wireless communication to and/or form the APC 108), and/or an on-board power source (e.g., rechargeable batteries). The particular APC 108 illustrated in FIGS. 1-5 should not be considered limiting, and in other embodiments, other types of APCs may be used as the circulation device 104 with fewer, additional, and/or different combinations or types of features as desired.

Under the influence of the pump 116, pool water may flow along a flow path (represented by arrow 122 in FIG. 3) in which pool water may enter the one or more inlets 112, pass through the body 110 (including a filter that may be within the body 110), and exit the body 110 through the one or more outlets 114. The pool water exiting the body 110 may have an exit flow, and the force from such flow may be used to circulate the pool water within the pool 102. In other words, the filtering and circulating of water through the APC 108 may be used as the filtering and circulating system of the pool 102.

In some embodiments, the APC 108 optionally includes a water treatment system 124 for dispensing one or more chemicals for sanitizing (or otherwise treating) pool water. Referring to FIGS. 3-5, in certain embodiments, the water treatment system 124 includes a housing 126 attached to the APC 108. The housing 126 may include a base 128 and a cover 130 that is separable from the base 128 such that an interior volume of the housing 126 is accessible. A water-treatment chemical (e.g. a solid chlorine tablet or “puck” 136) may be placed within the housing 126. If the chemical is designed to be consumed through use (as by erosion of the solid chlorine, for example), the separable housing 126 allows access to its interior volume to place an unconsumed chemical therein.

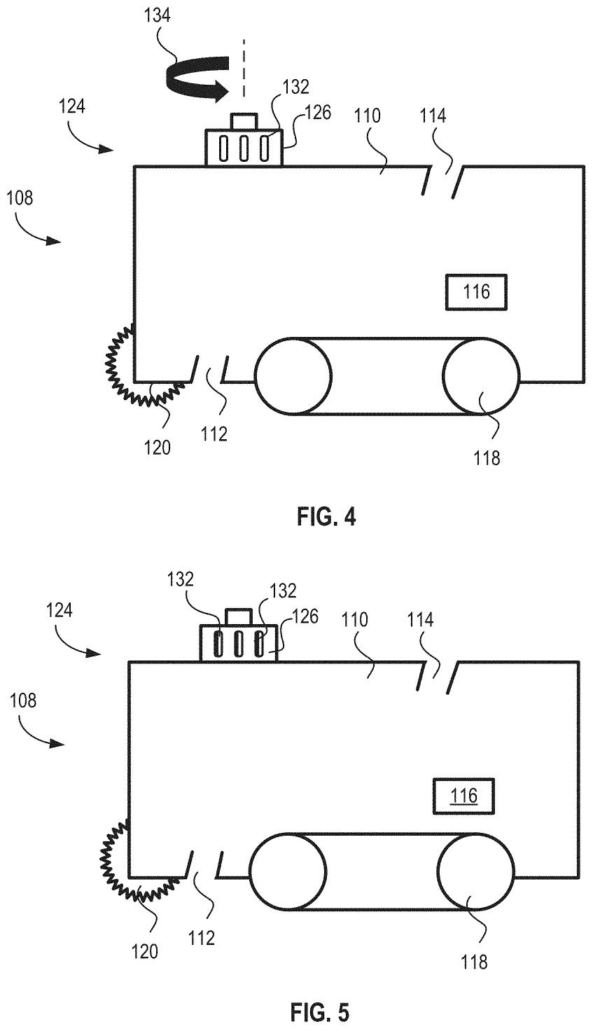

The housing 126 may have one or more openings 132 to allow pool water to flow through the housing 126 and to contact the chemical puck 136 or other chemical housed therein. Optionally, the openings 132 may be an adjustable size, and the flow rate through the housing may be varied by adjusting the size of the openings 132. In the embodiment illustrated, the openings 132 are adjustable by rotating the cover 130 relative to the base 128 (represented by arrow 134 in FIG. 4); however, other techniques of mechanisms for adjusting the size of the openings 132 may be utilized as desired. The adjustable openings 132 may be allow for various flow rate configurations as desired, such as an unobstructed configuration (FIG. 4) allowing for a maximum flow rate through the housing 126 and a partially obstructed configuration (FIG. 5) in which the size of the openings is less than FIG. 4, and thereby the flow rate is decreased. Optionally, the openings 132 may be fully closed such that water is not directed through the housing 126 and into contact with the puck 136.

The particular type of housing 126 and/or positioning of the housing 126 on the APC 108 should not be considered limiting, and in other embodiments the water treatment system 124 may include other types of housings and/or at other locations as desired. As a non-limiting example, the water treatment system 124 may be provided within the flow path 122 defined through the body 110 of the APC 108.

Exemplary concepts or combinations of features of the invention may include:

A. A “pipeless” pool.

B. An APC operating as the primary, if not sole, water-circulation system of a pool.

C. An APC according to statement B including a water-treatment chemical.

D. A method of filtering water of a pool comprising (a) introducing an APC into water of a pool lacking operational dedicated water-circulation equipment and (b) operating the APC in the pool.

E. A pool system comprising a pipeless pool lacking operational, fixed water-circulation equipment.

F. The pool system according to statement E, wherein the pool system further comprises a portable circulation device within the pool and movable within the pool, the portable circulation device configured as a water circulation system of the pool.

G. The pool system according to statement E or F, wherein the portable circulation device comprises a water treatment chemical.

H. The pool system according to any one of statements E-G, wherein the portable circulation device comprises a chemical puck as the water treatment chemical.

I. The pool system according to any one of statements E-H, wherein the portable circulation device comprises an automatic swimming pool cleaner (APC).

J. A pool system comprising a pool and a portable circulation device within the pool, wherein the portable circulation device is a primary water circulation system of the pool.

K. The pool system according to statement J, wherein the portable circulation device is the sole water circulation system of the pool.

L. The pool system according to statement J or K, wherein the portable circulation device is movable within the pool while circulating water of the pool.

M. The pool system according to any one of statements J-L, wherein the portable circulation device comprises an automatic swimming pool cleaner (APC) comprising one or more inlets, a pump, and one or more outlets.

N. The pool system according to any one of statements J-M, wherein the portable circulation device further comprises a skimmer.

O. The pool system according to any one of statements J-N, wherein the skimmer is tethered to the APC.

P. The pool system according to any one of statements J-O, wherein the APC further comprises a water treatment system comprising a water treatment chemical on-board the APC.

Q. An automatic swimming pool cleaner (APC) configured as a primary water circulation system of a pool, the APC further comprising a water treatment system on-board the APC.

R. The APC according to statement Q, wherein the water treatment system comprises a housing configured to receive a chemical tablet within an interior volume of the housing for treating water of the pool.

S. The APC according to statement Q or R, wherein the housing comprises a base and a cover, wherein the cover is separable from the base.

T. The APC according to any one of statements Q-S, wherein the housing comprises one or more openings enabling a flow of water into the interior volume of the housing and in contact with the chemical tablet, wherein the openings are adjustable for controlling a flow rate of water into the housing.

U. The APC according to any one of statements Q-T, wherein the housing comprises a base and a cover, wherein the cover is separable from the base, and wherein the cover is rotatable relative to the base for controlling a size of the openings.

V. A method of filtering water of a pool comprising (a) introducing an automatic swimming pool cleaner (APC) into water of a pool lacking operational dedicated water-circulation equipment and (b) operating the APC in the pool.

W. The method according to statement V, further comprising treating the water of the pool with a water treatment chemical on board the APC.

X. The method according to statement V or W, further comprising controlling a flow of the water contacting the water treatment chemical.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with APCs, persons skilled in the relevant field will recognize that the present invention conceivably could be employed in connection with other objects and in other manners. Finally, references to “pools” and “swimming pools” herein may also refer to spas or other water containing vessels used for recreation or therapy and for which cleaning of debris is needed or desired.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. In the figures and the description, like numerals are intended to represent like elements. As used herein, the meaning of “a,” “an,” and “the” includes singular and plural references unless the context clearly dictates otherwise.

The above-described aspects are merely possible examples of implementations, merely set forth for a clear understanding of the principles of the present disclosure. Many variations and modifications may be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. A pool system comprising a pipeless pool lacking operational, fixed water-circulation equipment, wherein the pipeless pool is a permanent or semi-permanent vessel.

2. The pool system of claim 1, wherein the pool system further comprises a portable circulation device within the pipeless pool and movable within the pipeless pool, the portable circulation device configured as a water circulation system of the pipeless pool.

3. The pool system of claim 2, wherein the portable circulation device comprises a water treatment chemical.

4. The pool system of claim 3, wherein the portable circulation device comprises a chemical puck as the water treatment chemical.

5. The pool system of claim 2, wherein the portable circulation device comprises an automatic swimming pool cleaner (APC).

6. A pool system comprising a pool and a portable circulation device within the pool, wherein the portable circulation device is a primary water circulation system of the pool and wherein the pool is a permanent or semi-permanent vessel.

7. The pool system of claim 6, wherein the portable circulation device is the sole water circulation system of the pool.

8. The pool system of claim 6, wherein the portable circulation device is movable within the pool while circulating water of the pool.

9. The pool system of claim 6, wherein the portable circulation device comprises an automatic swimming pool cleaner (APC) comprising one or more inlets, a pump, and one or more outlets.

10. The pool system of claim 9, wherein the portable circulation device further comprises a skimmer.

11. The pool system of claim 10, wherein the skimmer is tethered to the APC.

12. The pool system of claim 9, wherein the APC further comprises a water treatment system comprising a water treatment chemical on-board the APC.

13. An automatic swimming pool cleaner (APC) configured as a primary water circulation system of a pool that is a permanent or semi-permanent vessel, the APC further comprising a water treatment system on-board the APC.

14. The APC of claim 13, wherein the water treatment system comprises a housing configured to receive a chemical tablet within an interior volume of the housing for treating water of the pool.

15. The APC of claim 14, wherein the housing comprises a base and a cover, wherein the cover is separable from the base.

16. The APC of claim 14, wherein the housing comprises one or more openings enabling a flow of water into the interior volume of the housing and in contact with the chemical tablet, wherein the one or more openings are adjustable for controlling a flow rate of water into the housing.

17. The APC of claim 16, wherein the housing comprises a base and a cover, wherein the cover is separable from the base, and wherein the cover is rotatable relative to the base for controlling a size of the one or more openings.

18. A method of filtering water of a pool comprising (a) introducing an automatic swimming pool cleaner (APC) into water of a permanent or semi-permanent pool lacking operational dedicated water-circulation equipment and (b) operating the APC in the pool.

19. The method of claim 18, further comprising treating the water of the pool with a water treatment chemical on board the APC.

20. The method of claim 19, further comprising controlling a flow of the water contacting the water treatment chemical.
